(19) United States
(12) Patent Application Publication
(10) Pub. No.: US 2008/0241529 A1
(43) Pub. Date: Oct. 2, 2008

(54) Flameproofed adhesive and sealing materials

(75) Inventors: Harald Bauer, Kerpen (DE); Mathias Dietz, Simmerath (DE); Werner Krause, Huerth (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/079,211

(22) Filed: Mar. 25, 2008

(30) Foreign Application Priority Data
Mar. 29, 2007 (DE) 10 2007 015 083.2

(51) Int. Cl. C09J 101/00; C08K 5/5313; C09J 103/00; C09J 123/00; C09J 175/04; C09J 167/00; C09J 163/00; B32B 27/06; C09J 153/00; C09J 109/00; C09J 133/04; C09J 105/00; C08K 5/3492

(52) U.S. Cl. 428/355 R; 524/126; 524/100; 106/203.1; 106/210.1; 106/217.7

(57) ABSTRACT

The invention relates to flameproofed adhesive and sealing materials containing 0.1-99.9% by weight of adhesive or thermoplastic polymer and 0.1-99.9% by weight of flameproofing agent, wherein the flameproofing agent contains at least one phosphinic acid salt of the formula (I) and/or one diphosphinic acid salt of the formula (II)

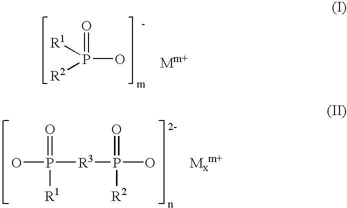

in which
R¹, R² are identical or different and are C₁-C₆-alkyl, linear or branched, and/or aryl;
R³ is C₁-C₁₀-alkylene, linear or branched, C₆-C₁₀-arylene, C₆-C₁₀-alkylarylene or C₆-C₁₀-arylalkylene;
M is Mg, Ca, Al, Zn, Sb, Sn, Ge, Zn, Ti, Fe, Zr, Ce, Bi, Sr, Mn, Li, Na, K and/or a protonated nitrogen base;
m is 1 to 4; n is 1 to 4 and x is 1 to 4, the adhesive polymers being acrylate resins, polyurethane resins, saturated and unsaturated polyester resins, styrene-butadiene copolymers, vinyl acetate copolymers, silicones, synthetic rubber and/or polyolefin resins.

The invention relates to flameproofed adhesive and sealing materials, processes for the preparation thereof, moldings which contain them and their use.

Non-flameproofed adhesive and sealing materials are known. Such systems can be treated with halogen-containing flameproofing agents. A further possibility for treatment comprises inorganic intumescent systems, in particular ammonium polyphosphate. The latter is intended for structural fireproofing. It works by decomposing at a specified temperature and gaseous decomposition products cause the coatings to swell, forming in this way an insulating layer which protects structural elements from the action of fire.

A characteristic disadvantage of the intumescent systems based on ammonium polyphosphate is a substantial release of alkaline gases, especially at elevated storage temperature. Also typical are inorganic surface properties which in some cases reduce the compatibility with polymers and which have to be counteracted with surface coatings (compatibilizers). Another disadvantage is the low residual solubility of the ammonium polyphosphate, which can lead to blooming when used in polymeric moldings.

It is an object of the invention to avoid these disadvantages. According to the invention, the object is achieved by flameproofed adhesive and sealing materials which contain flameproofing agents based on phosphinic acid salts. The flameproofing agent according to the invention is non-intumescent, stable at elevated storage temperatures and to hot weathering influences and has a heat resistance as required in the wave soldering of electrical components.

The invention therefore relates to flameproofed adhesive and sealing materials containing 0.1-99.9% by weight of adhesive or thermoplastic polymer and 0.1-99.9% by weight of flameproofing agent, wherein the flameproofing agent contains at least one phosphinic acid salt of the formula (I) and/or one diphosphinic acid salt of the formula (II)

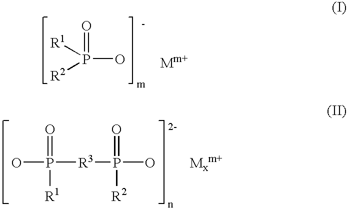

in which
R¹, R² are identical or different and are C₁-C₆-alkyl, linear or branched, and/or aryl;
R³ is C₁-C₁₀-alkylene, linear or branched, C₆-C₁₀-arylene, C₆-C₁₀-alkylarylene or C₆-C₁₀-arylalkylene;
M is Mg, Ca, Al, Zn, Sb, Sn, Ge, Zn, Ti, Fe, Zr, Ce, Bi, Sr, Mn, Li, Na, K and/or a protonated nitrogen base;
m is 1 to 4; n is 1 to 4 and x is 1 to 4, the adhesive polymers being acrylate resins, polyurethane resins, saturated and unsaturated polyester resins, styrene-butadiene copolymers, vinyl acetate copolymers, silicones, synthetic rubber and/or polyolefin resins.

Preferably, R¹, R² are identical or different and are methyl, ethyl, n-propyl, isopropyl, n-butyl, sec-butyl, tert-butyl, n-pentyl and/or phenyl.

Preferably, R³ is methylene, ethylene, n-propylene, isopropylene, n-butylene, tert-butylene, n-pentylene or n-octylene; phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

The phosphinic acid salt of the formula (I) and/or the diphosphinic acid salt of the formula (II) are preferably present in amounts of from 70 to 100% by weight in the flameproofing agent.

The flameproofing agent preferably contains

a) from 30 to 99.9% by weight of phosphinic acid salt of the formula (I) and/or diphosphinic acid salt of the formula (II) and
b) from 0.1 to 70% by weight of synergistic agent.

The flameproofing agent particularly preferably contains

a) from 60 to 99% by weight of phosphinic acid salt of the formula (I) and/or diphosphinic acid salt of the formula (II) and
b) from 1 to 40% by weight of synergistic agent.

The synergistic agent preferably contains a nitrogen, phosphorus or phosphorus-nitrogen compound.

The synergistic agent is preferably allantoin, cyanuric acid, glycoluril, urea, melamine, melam, melem, melon, melamine phosphate, melamine pyrophosphate, melamine polyphosphate, melam polyphosphate, melem polyphosphate, melon polyphosphate, melamine cyanurate, piperazine phosphate, piperazine pyrophosphate, carbodiimide, sterically hindered phenols, phosphine oxide, hypophosphite, cyclic phosphonates, triaryl(alkyl phosphites, alkyl- and aryl substituted phosphates, aluminum, tin, boron, magnesium, calcium and cerium compounds, zinc oxide, zinc carbonate, zinc stannate, zinc borate, zinc hydrogen phosphate, zinc pyrophosphate, zinc oleate, zinc stearate and/or zinc phosphate.

The adhesive or thermoplastic polymers are preferably those which are based on glue, cellulose, modified cellulose, cellulose derivatives, starch, amylose, amylopectin or polysaccharides.

The adhesive or thermoplastic polymers are preferably those which are based on an elastomer, such as natural rubber, homopolymers or copolymers of conjugated hydrocarbondienes, chloroprene homopolymers or copolymers, elastomers containing carboxyl groups, rubber derivatives, regenerated material, synthetic rubber, acrylonitrile-butadiene rubber containing carboxyl groups, butyl rubber, elastomers based on homopolymers or copolymers of unsaturated aliphatic hydrocarbons having only one C═C double bond and the derivatives thereof.

The adhesive or thermoplastic polymers are preferably those which are based on homopolymers or copolymers of ethylene, propylene, polyethylene, polypropylene, copolymers of ethylene, propylene or isobutene, homopolymers or copolymers of hydrocarbons having four or more carbon atoms and derivatives obtained by modification, such as chemical aftertreatment, reaction with halogens or halogen-containing compounds or oxidation.

If the flameproofed adhesive and sealing material is used as hotmelts, the thermoplastic polymers are ethylene copolymers, organopolysiloxanes, atactic poly-alpha-olefins (APAO), polyisobutylene, styrene-butadiene-styrene block polymers, styrene-isoprene-styrene block polymers, polyamides, polyesters, polyvinyl acetate plastomers, copolyesters, butyl rubbers, ternary and quaternary copolyamides, polyurethanes and/or epoxy resins.

The invention also relates to the use of flameproofed adhesive and sealing materials as claimed in one or more of claims 1 to 13 in moldings.

The moldings are preferably laminates which contain at least one nontacky substrate layer and at least one adhesive layer, wherein at least one of the layers contains the flameproofed adhesive and sealing materials as claimed in one or more of claims 1 to 13.

The molding preferably consists of flexible copper-clad substrate, solder resist and flameproofed adhesive and sealing material as claimed in one or more of claims 1 to 13.

The molding is preferably produced by applying the flameproofed adhesive and sealing material to a substrate layer and curing it by exposure to light.

The molding is preferably produced by laminating a flameproofed adhesive and sealing material with a substrate film.

The molding is preferably produced by coating a substrate material on both sides with flameproofed adhesive and sealing material.

The invention finally also relates to the use of the flameproofed adhesive and sealing material as claimed in one or more of claims 1 to 13 and/or of the moldings as claimed in one or more of claims 15 to 19 for flat cables, flexible circuit boards, interior automotive trim, electrical semiconductors, covering layers, optical films for the protection of windows from sunlight, circuit boards, optical conductors, coils for demagnetization, for the fixing of electrical assemblies, for the production of electrical insulation materials, medium- and high-voltage insulators, cable terminal boxes, cable sleeves, for the potting or embedding of electrical or electronic or photovoltaic assemblies, for sealing, for the production of coatings, for the insulation of electrical conductors and for the adhesive bonding and lamination of the abovementioned substrates, diapers, hospital hygiene articles, feminine hygiene articles, operating theater requisites, incontinence articles, adhesive bonding of cardboard packaging, packaging materials, adhesive tapes, labels, insulating glass panes, adhesive bonds of pipes or injection molded parts, contact adhesive materials, flexible adhesive bonds of printed circuit boards, heat-activatable contact adhesive tapes, for the potting of electrical or electronic components and/or as heat-curing epoxy molding compounds (EMC).

A flameproofing agent containing 100% by weight of phosphinic acid salt of the formula (I) and/or diphosphinic acid salt of the formula (II) is preferred.

The L color values of the flameproofing agent used are preferably from 81 to 99.9, particularly preferably from 85 to 98. The a color values of the flameproofing agent used are preferably from −4 to +9, particularly preferably from −2 to +6. The b color values of the flameproofing agent used are preferably from −2 to +6, preferably from −1 to +3. The color values are stated in the system according to Hunter (CIE-LAB System, Commission Internationale d'Eclairage). L color values range from 0 (black) to 100 (white), a color values from −a (green) to +a (red) and b color values from −b (blue) to +b (yellow).

Preferably, the residual moisture content of the flameproofing agent used is from 0.05 to 30% by weight, preferably from 0.1 to 5% by weight.

Preferably the median particle diameter (d₅₀) of the flameproofing agent used is from 0.01 to 500 μm, preferably from 0.1 to 250 μm.

Preferably, the solubility of the flameproofing agent used is from 0.1 to 1% by weight, particularly preferably from 0.1 to 0.5% by weight, at room temperature. The lower solubility of the flameproofing agent results in increased resistance to weathering, inter alia, at higher ambient temperature.

The flameproofing agent is preferably non-intumescent up to 300° C.

Preferably, M in the formulae (I) and (II) is calcium, aluminum, titanium or zinc.

Protonated nitrogen bases are preferably understood as meaning the protonated bases of ammonia, melamine, monoethanolamine, diethanolamine, triethanolamine, in particular NH₄⁺.

Preferred dialkylphosphinic acid salts are aluminum trisdiethylphosphinate, aluminum trismethylethylphosphinate, aluminum trisethylbutylphosphinate, titanyl bisdiethylphosphinate, titanium tetrakisdiethylphosphinate, titanyl bismethylethylphosphinate, titanium tetrakismethylethylphosphinate, titanyl bisethylbutylphosphinate, titanium tetrakisethylbutylphosphinate, zinc bisdiethylphosphinate, zinc bismethylethylphosphinate, zinc bisethylbutylphosphinate and mixtures thereof.

The L color values of the phosphinic acid salt used are preferably from 81 to 99.9, particularly preferably from 90 to 98. The a color values of the phosphinic acid salt used are preferably from −2 to +2, particularly preferably from −1 to +1.5. Preferably, the b color values of the phosphinic acid salt used are from −2 to +8, preferably from −1 to +7.

Preferably, the residual moisture content of the phosphinic acid salt used is from 0.05 to 10% by weight, preferably from 0.1 to 2.5% by weight.

Preferably, the median particle diameter of the phosphinic acid salt used is from 0.01 to 500 μm, preferably from 1 to 100 μm.

The bulk density of the phosphinic acid salt used is preferably from 80 to 800 g/l, particularly preferably from 200 to 700 g/l.

The solubility of the phosphinic acid salt used is preferably from 0.1 to 1% by weight, particularly preferably from 0.1 to 0.5% by weight, at room temperature.

Suitable synergistic agents are melamine phosphate (e.g. Melapur® MPH, Melapur® MP from Ciba-DSM Melapur), melamine acetate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate (e.g. Budit® 311 from Budenheim, MPP®-B from Sanwa Chemicals), melamine polyphosphates, melam polyphosphates, melem polyphosphates and/or melon polyphosphates.

Melamine polyphosphates, such as Melapur® 200/70, Melapur® CGX FR231 from Ciba-DSM Melapur, Budit® 3141, 3141 CA and 3141 CB and melamine polyphosphate/melamine pyrophosphate of the types 13-1100, 13-1105, 13-1115, MPP02-244 from Hummel-Croton and PMP®-100 or PMP®-200 from Nissan Chemical Industries, Japan, are particularly preferred.

Further preferred melamine polyphosphates are reaction products of melamine with phosphoric acid or reaction products of condensates of melamine with phosphoric acid and mixtures of said products. Condensates of melamine are, for example, melem, melam or melon or compounds of this type which have a higher degree of condensation and mixtures thereof.

The reaction products with phosphoric acid are understood as meaning compounds which form by reaction of melamine or the condensed melamine compounds, such as melam, melem or melon, etc., with phosphoric acid.

Examples of these are melamine polyphosphate, melam polyphosphate (e.g. PMP-200™ from Nissan Chemical Industries) and melem polyphosphate (e.g. PMP-300™ from Nissan Chemical Industries) or mixed polysalts. Suitable melamine polyphosphates are also those which are obtained by thermal aftertreatment of reaction products of melamine and/or of condensates of melamine with phosphoric acid.

Preferred synergistic agents are furthermore oligomeric esters of tris(hydroxyethyl) isocyanurate with aromatic polycarboxylic acids, benzoguanamine, tris(hydroxyethyl) isocyanurate, melamine condensates, such as melam, melem and/or melon, melamine cyanurate (e.g. Melapur® MC or Melapur® MC XL from Ciba-DSM Melapur), dicyandiamide and/or guanidine and melamine ammonium polyphosphates.

Preferred synergistic agents are furthermore nitrogen-containing phosphates of the formulae (NH₄)_{y}H_{3-y}PO₄ or (NH₄PO₃)_{z}, where y is from 1 to 3 and z is from 1 to 10 000.

Preferred synergistic agents are furthermore piperazine phosphates and/or piperazine pyrophosphates, such as, for example, ADK® STAB (ADEKASTAB) FP-4100 (from Asahi Denka).

According to the invention, preferred synergistic agents are nitrogen compounds, such as allantoin, melamine, cyanuric acid, glycoluril, urea and their derivatives, e.g. those of the formulae (III) to (VIII) or mixtures thereof.

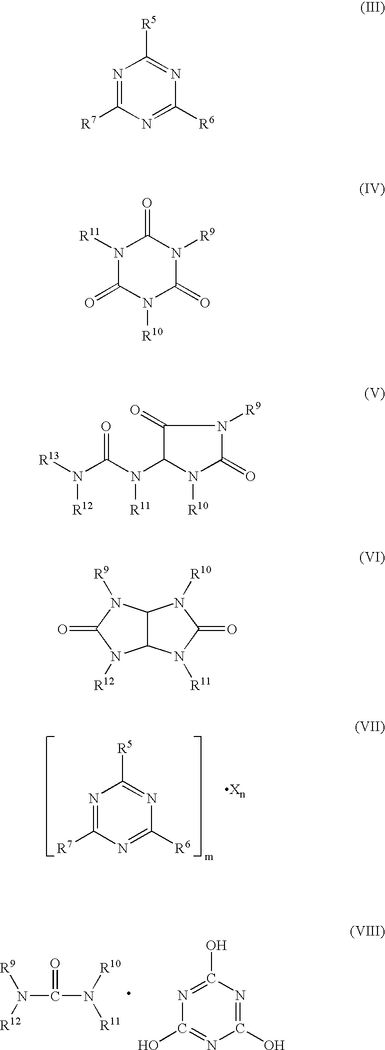

in which
R⁵ to R⁷ are hydrogen, C₁-C₈-alkyl, C₅-C₁₆-cycloalkyl or C₅-C₁₆-alkylcycloalkyl, optionally substituted by a hydroxyl or a C₁-C₄-hydroxyalkyl function, C₂-C₈-alkenyl, C₁-C₈-alkoxy, C₁-C₈-acyl, C₁-C₈-acyloxy, C₆-C₁₂-aryl or C₆-C₁₂-arylalkyl, —OR⁸ and —N(R⁸)R⁹, and N-alicyclic or N-aromatic,
R⁸ is hydrogen, C₁-C₈-alkyl, C₅-C₁₆-cycloalkyl or C₅-C₁₆-alkylcycloalkyl, possibly substituted by a hydroxyl or a C₁-C₄-hydroxyalkyl function, C₂-C₈-alkenyl, C₁-C₈-alkoxy, C₁-C₈-acyl, C₁-C₈-acyloxy or C₆-C₁₂-aryl or C₆-C₁₂-arylalkyl,
R⁹ to R¹³ are the same groups as R⁸ and —O—R⁸,
m and n independently of one another are 1, 2, 3 or 4 and X are acids which can form adducts with triazine compounds (III).

Other preferred synergistic agents are carbodiimides (e.g. Stabaxol® 1, Stabaxol® P, Stabaxol® KE 9193 from Rhein Chemie), N,N′-dicyclohexylcarbodiimide and/or polyisocyanates (e.g. Basonat® HI 100 or Vestanat® T 1890/100), carbonylbis-caprolactam (from Allinco) or styrene-acrylate polymers (Joncryl® ADR-4357 from Johnson); sterically hindered phenols (e.g. Hostanox OSP 1, from Clariant), sterically hindered amines and light stabilizers (e.g. Chimasorb® 944, Hostavin® types).

Other preferred synergistic agents are phosphine oxides, such as, for example, triphenylphosphine oxide, tritolylphosphine oxide, trisnonylphenylphosphine oxide, tricyclohexylphosphine oxide, tris(n-butyl)phosphine oxide, tris(n-hexyl)phosphine oxide, tris(n-octyl)phosphine oxide, tris(cyanoethyl)phosphine oxide, benzylbis(cyclohexyl)phosphine oxide, benzylbisphenylphosphine oxide, phenylbis(n-hexyl)phosphine oxide. Oxidized reaction products of phosphine with aldehydes, in particular of tert-butylphosphine with glyoxal, are furthermore preferred. Also suitable are triphenylphosphine sulfide; elemental phosphorus, such as, for example, red and black phosphorus, and finally phosphonites.

Other preferred synergistic agents are inorganic hypophosphites, such as calcium hypophosphite, and organic hypophosphites, such as cellulose hypophosphite esters, esters of hypophosphorous acids with diols, such as, for example, of 1,10-dodecyldiol.

The suitable synergistic agents include substituted phosphinic acids and derivatives thereof, such as, for example, sodium benzenephosphinate (Na(H)C₆H₅PO₂) and calcium benzenephosphinate and Zn((CH₃)₂PO₂)₂, Zn((C₂H₅)CH₃PO₂)₂ and Al((C₂H₅)(CH₃)PO₂)₃, diphenylphosphinic acid, di-p-tolylphosphinic acid, dicresylphosphinic anhydride, compounds such as hydroquinone, ethylene glycol and propylene glycol bis(diphenylphosphinic acid) ester, aryl(alkyl)phosphinamides, such as, for example, diphenylphosphinic acid dimethylamide, and sulfonamidoaryl(alkyl)phosphinic acid derivatives, such as, for example, p-tolylsulfonamidodiphenylphosphinic acid.

Other preferred synergistic agents are inorganic coordination polymers of aryl(alkyl)phosphinic acids, such as, for example, poly-b-sodium(I) methylphenylphosphinate.

Other suitable synergistic agents are cyclic phosphonates which are derived from pentaerythritol, neopentylglycol or pyrocatechol, e.g. Amgard® P45 from Albright & Wilson.

Other preferred synergistic agents are triaryl(alkyl) phosphites, such as, for example, triphenyl phosphite, tris(4-decylphenyl) phosphite, tris(2,4-di-tert-butylphenyl) phosphite, trisnonylphenyl phosphite (for example Irgaphos® TNPP from Ciba Geigy AG) or phenyl didecyl phosphite.

Other preferred synergistic agents are diphosphites, such as, for example, propylene glycol 1,2-bis(diphosphite), or cyclic phosphites which are derived from pentaerythritol, neopentylglycol or pyrocatechol.

Other preferred synergistic agents are methyl neopentyl glycol phosphonate and phosphite and dimethyl pentaerythrityl diphosphonate and phosphite.

Other preferred synergistic agents are hypodiphosphates, such as, for example, tetraphenyl hypodiphosphate or bisneopentyl hypodiphosphate.

Other preferred synergistic agents are alkyl- and aryl-substituted phosphates, such as, for example, phenyl bisdodecyl phosphate, phenyl ethyl hydrogen phosphate, phenyl bis(3,5,5-trimethylhexyl) phosphate, ethyl diphenyl phosphate, 2-ethylhexyl ditolyl phosphate, diphenyl hydrogen phosphate, bis(2-ethylhexyl) p-tolyl phosphate, tritolyl phosphate, bis(2-ethylhexyl)phenyl phosphate, dinonyl phenyl phosphate, phenyl methyl hydrogen phosphate, didodecyl p-tolyl phosphate, p-tolyl bis(2,5,5-trimethylhexyl) phosphate or 2-ethylhexyl diphenyl phosphate, triphenyl phosphate and resorcinol bis(diphenyl phosphate), such as, for example, Fyroflex®-RDP (from Akzo Nobel) and CR® 7.33-S (from Daihachi).

Other preferred synergistic agents are cyclic phosphates, such as diphenyl pentaerythrityl diphosphate and phenyl neopentyl phosphate.

Other preferred synergistic agents are preferably halogen-free, polymeric phosphorus compounds which form by the reaction of a phosphonyl chloride, such as, for example, phenyl-, methyl-, propyl-, styryl- and vinylphosphonyl dichloride, with bifunctional phenols, such as, for example, hydroquinone, resorcinol, 2,3,5-trimethylhydroquinone, bisphenol A or tetramethylbisphenol A.

Other preferred synergistic agents are compounds which can be prepared by reaction of phosphorus oxytrichloride or phosphoric acid ester dichlorides with a mixture of mono-, bi- and trifunctional phenols and other compounds carrying hydroxyl groups.

Other preferred synergistic agents are polymeric phosphonates which are formed by transesterification reactions of phosphonic acid esters with bifunctional phenols or by reactions of phosphonic acid esters with diamines or hydrazides.

Other preferred synergistic agents are oligomeric pentaerythrityl phosphites, phosphates and phosphonates, such as, for example, Mobil® Antiblaze 19 (from Mobil Oil).

Other preferred synergistic agents are antioxidants (e.g. Hostanox® P-EPQ from Clariant) and release agents (Licomont® types from Clariant).

Preferred synergistic agents are compounds of the elements of the first subgroup, of the second main group and subgroup and of the third main group and subgroup, of the fourth main group and subgroup, of the eighth subgroup, compounds of the lanthanide series. Compounds of the elements aluminum, boron, calcium, magnesium, zinc and tin are particularly preferred.

Preferred synergistic agents are aluminum compounds, e.g. aluminum oxide, aluminum oxide hydroxide (boehmite, diaspore), aluminum hydroxide (bayerite, gibbsite, hydrargillite) or aluminum phosphate.

Preferred synergistic agents are tin compounds, e.g. tin oxide, hydrated tin oxides, tin(II) hydroxide or tin sulfide.

Preferred synergistic agents are boron compounds, e.g. boron phosphate (Budit® 1304, from Budenheim).

Preferred synergistic agents among the magnesium compounds are magnesium oxide, magnesium hydroxide (e.g. Magnifin® H5 from Albermarle), magnesium oxide hydroxides, hydrotalcites, dihydrotalcite, magnesium carbonates, basic magnesium carbonates, magnesium calcium carbonates, monobasic, dibasic, tribasic magnesium phosphate, magnesium hydrogen phosphate, magnesium pyrophosphate or magnesium borate (Storflam® MGB 11 from Storey).

Preferred synergistic agents among the calcium compounds are calcium borate, calcium pyroborate, calcium carbonate, calcium hydroxide, monobasic, dibasic, tribasic calcium phosphate, calcium hydrogen phosphate and calcium pyrophosphate.

Preferred synergistic agents are zinc compounds, e.g. zinc oxide (e.g. zinc oxide active from Rhein Chemie, Brüggemann KG, zincite or calamine; standard zinc oxide, zinc white G6, zinc oxide 2011, zinc oxide F-80, zinc white pharma 8, zinc white pharma A, zinc white red seal, zinc white white seal from Grillo-Werke AG), zinc hydroxide and hydrated zinc oxide.

Preferred synergistic agents are zinc salts of the oxo acids of the fourth main group (anhydrous zinc carbonate, basic zinc carbonate, zinc hydroxide carbonate, basic hydrated zinc carbonate, (basic) zinc silicate, zinc hexafluorosilicate, zinc hexafluorosilicate hexahydrate, zinc stannate, and basic zinc magnesium aluminum carbonate).

Preferred synergistic agents are zinc salts of the oxo acids of the third main group (zinc borate, e.g. Firebrake® ZB, Firebrake® 415 from Borax).

Preferred synergistic agents are zinc salts of the oxo acids of the fifth main group (zinc phosphate, zinc hydrogen phosphate, zinc pyrophosphate).

Preferred synergistic agents are zinc salts of the oxo acids of the transition metals (basic zinc chromate (VI) (zinc yellow), zinc chromite, zinc molybdate, e.g. Kemgard® 911 B, zinc permanganate, zinc molybdate-magnesium silicate, e.g. Kemgard® 911 C from Sherwin-Williams Company, zinc permanganate).

Preferred synergistic agents are zinc salts having organic anions, such as zinc salts of mono-, di-, oligo- and polycarboxylic acids (salts of formic acid (zinc formates), of acetic acid (zinc acetates, zinc acetate dihydrate, Galzin), of trifluoroacetic acid (zinc trifluoroacetate hydrate), zinc propionate, zinc butyrate, zinc valerate, zinc caprylate, zinc oleate, zinc stearate (Liga 101 from Greven Fett-Chemie), of oxalic acid (zinc oxalate), of tartaric acid (zinc tartrate), citric acid (tribasic zinc citrate dihydrate), benzoic acid (benzoate), zinc salicylate, lactic acid (zinc lactate, zinc lactate trihydrate), acrylic acid, maleic acid, succinic acid, of amino acids (glycine), of acidic hydroxo functions (zinc phenolate etc.), zinc para-phenolsulfonate, zinc para-phenolsulfonate hydrate, zinc acetylacetonate hydrate, zinc tannate, zinc dimethyldithiocarbamate, zinc trifluoromethanesulfonate.

Zinc phosphides, zinc sulfides, zinc selenides and zinc tellurides are also suitable.

Preferred synergistic agents among the cerium compounds are cerium(III) carbonate hydrate, cerium(IV) oxide, cerium(III) phosphate, cerium molybdate, cerium tungstate and cerium vanadate.

The L color values of the synergistic agents used are preferably from 81 to 99.9, particularly preferably from 85 to 98; the a color values of the synergistic agents used are from −2 to +2, particularly preferably from −1 to +1.5 and the b color values of the synergistic agents used are from −2 to +8, preferably from −1 to +7.

Preferably, the residual moisture content of the synergistic agents used is from 0.05 to 10% by weight, preferably from 0.1 to 5% by weight.

Preferably, the median particle diameter of the synergistic agents used is from 0.1 to 500 μm, preferably from 1 to 100 μm.

The solubility of the synergistic agents used is preferably from 0.1 to 1% by weight, particularly preferably from 0.1 to 0.5% by weight, at room temperature.

Adhesive polymers according to the invention are acrylate resins, polyurethane resins, saturated and unsaturated polyester resins, resins based on styrene-butadiene copolymers, vinyl acetate copolymers, silicones, synthetic rubber, acrylate rubber, epoxy resins and polyolefin resin. According to the invention, the glass transition temperature of the adhesive polymer is preferably less than or equal to 25° C.

Flameproofed adhesive and sealing materials according to the invention contain 50-99% by weight of adhesive polymers and 1-50% by weight of flameproofing agent.

According to the invention, the use of flameproofed polymer molding materials containing 50-99.9% by weight of adhesive polymers and 1-50% by weight of flameproofing agent according to the invention is preferred for flameproofed adhesive and sealing materials.

Adhesive or thermoplastic polymers according to the invention for the flameproofed adhesive and sealing materials according to the invention are based on glue, cellulose, modified cellulose, cellulose derivatives, starch, amylose or amylopectin or their derivatives or degradation products, polysaccharides or their derivatives, organic non-macromolecular compounds having at least one unsaturated polymerizable C—C bond.

Adhesive or thermoplastic polymers according to the invention for the flameproofed adhesive and sealing materials according to the invention are based on an elastomer, such as natural rubber, homopolymers or copolymers of conjugated hydrocarbon dienes, chloroprene homopolymers or copolymers, elastomers containing carboxyl groups, rubber derivatives, regenerated material, synthetic rubber, acrylonitrile-butadiene rubber containing carboxyl groups, butyl rubber, elastomers based on homopolymers or copolymers of unsaturated aliphatic hydrocarbons having only one C═C double bond and derivatives thereof.

Adhesive or thermoplastic polymers according to the invention for the flameproofed adhesive and sealing materials according to the invention are based on homopolymers or copolymers of ethylene, propylene, polyethylene, polypropylene, copolymers of ethylene, propylene or isobutene, homopolymers or copolymers of hydrocarbons having four or more carbon atoms and derivatives obtained by modification, such as chemical aftertreatment, reaction with halogens or halogen-containing compounds or oxidation.

Adhesive or thermoplastic polymers according to the invention for the flameproofed adhesive and sealing materials according to the invention are based on homopolymers or copolymers of compounds which contain one or more unsaturated aliphatic groups. Each having a C═C double bond, of which at least one is terminated with: an aromatic carbocyclic ring, a halogen, an alcohol, ether, aldehyde, keto, acetal, acyloxy or carboxyl function, a heterocyclic ring containing an oxygen atom, a single or double bond to nitrogen or sulfur or by a heterocyclic ring containing a nitrogen or sulfur atom.

Adhesive or thermoplastic polymers according to the invention for the flameproofed adhesive and sealing materials according to the invention are based on homopolymers or copolymers which contain no unsaturated group of a secondary chain and which contain one or more C═C double bonds in a carbocyclic or heterocyclic system.

Adhesive or thermoplastic polymers according to the invention for the flameproofed adhesive and sealing materials according to the invention are based on homopolymers or copolymers of compounds which contain one or more unsaturated aliphatic groups, at least one of which contains two or more C═C double bonds.

Suitable adhesive or thermoplastic polymers for the flameproofed adhesive and sealing materials according to the invention are based on homopolymers or copolymers of compounds which contain one or more C—C triple bonds.

Adhesive or thermoplastic polymers according to the invention for the flameproofed adhesive and sealing materials according to the invention are based on graft polymers in which the grafted component is obtained by reactions which affect only the unsaturated C—C bonds.

Adhesive or thermoplastic polymers according to the invention for the flameproofed adhesive and sealing materials according to the invention are also based on
polyacetals and derivatives thereof,
condensation polymers of aldehydes or ketones (with polyalcohols or polynitriles),
epoxy resins and derivatives thereof,
macromolecules which are obtained by reactions which form a C—C bond in the main chain,
polyesters which are obtained by reactions which form a carboxyl ester bond in the main chain (based on polyesteramides, polyesterimides),
polycarbonates and derivatives thereof,
polyethers which are obtained by reactions which form an ether bond in the main chain (based on polyacetals, epoxy resins, polythioethers, polyethersulfones),
macromolecules which are obtained by reactions which form an oxygen-containing bond—with or without carbon—in the main chain,
polyureas or polyurethanes or derivatives thereof,
polyamides which are obtained by reactions which form a carboxamide bond in the main chain (polyhydrazides, polyamidoimides) and their derivatives,
polyamides which are obtained by reactions which form a nitrogen-containing bond—with or without oxygen—or a bond containing only carbon in the main chain,
macromolecules which are obtained by reactions which form a sulfur-containing bond (polysulfones) in the main chain, with or without nitrogen, oxygen or carbon,
macromolecules which are obtained by reactions which form a silicon-containing bond in the main chain,
proteins and their derivatives,
oils, fats or waxes,
natural resins and their derivatives,
bituminous substances, e.g. asphalt, tar, pitch,
lignin-containing substances and
   natural macromolecules and their derivatives.

Suitable acrylate resins are homo- and copolymers based on the following monomers: C₁₋₁₄-alkyl acrylates or alkyl methacrylates, i.e. alkyl esters of acrylic acid or alkyl esters of methacrylic acid, such as, for example, ethyl acrylate, propyl acrylate, isopropyl acrylate, n-butyl acrylate, isobutyl acrylate, sec-butyl acrylate, tert-butyl acrylate, pentyl acrylate, hexyl acrylate, heptyl acrylate, octyl acrylate, 2-ethylhexyl acrylate, nonyl acrylate, decyl acrylate, lauryl acrylate, stearyl acrylate, acrylic acid, 2-hydroxyethyl acrylate, isobornyl acrylate, methyl methacrylate, ethyl methacrylate, propyl methacrylate, isopropyl methacrylate, n-butyl methacrylate, isobutyl methacrylate, sec-butyl methacrylate, tert-butyl methacrylate, pentyl methacrylate, hexyl, methacrylate, heptyl methacrylate, octyl methacrylate, 2-ethylhexyl methacrylate, nonyl methacrylate, decyl methacrylate, lauryl methacrylate, stearyl methacrylates, 2-hydroxyethyl methacrylate, phosphoxyethyl methacrylate. Suitable acrylates are cycloalkyl esters of acrylic acid, e.g. cyclohexyl acrylate, and cycloalkyl esters of methacrylic acid, e.g. cyclohexyl methacrylates.

Suitable acrylates are glycidyl acrylate and glycidyl methacrylate; carboxylic acid-modified acrylate elastomers and methyl methacrylate-butadiene-acrylonitrile-styrene copolymers; ethylene-acrylic acid copolymers, ethylene-acrylic acid-ethyl acrylate copolymers, ethylene-methyl acrylate-methacrylic acid copolymers, ethylene-vinyl acetate (EVA) copolymers, ethylene-vinyl acetate-ethyl acrylate copolymers, ethylene-butyl acrylate (EBA) copolymers, ethylene-methyl acrylate (EMA) copolymers, ethylene-ethyl acrylate copolymers, ethylene-n-hexyl acrylate copolymers, ethylene-2-ethylhexyl acrylate copolymers, ethylene-glycidyl methacrylate copolymers, ethylene-glycidyl methacrylate-ethyl acrylate copolymers and also homo- and copolymers containing the following monomers: methyl (meth)acrylate 0-40% by weight, butyl acrylate 0-6% by weight, 2-ethylhexyl acrylate 10-98% by weight, acrylic acid 0.30% by weight, hydroxyethyl acrylate 0-10% by weight.

According to the invention, a flameproofed adhesive and sealing material containing 40-99% by weight of acrylate polymer, 1-60% by weight of flameproofing agent and 0.1-10% by weight of photoinitiator or free radical initiator, such as, for example, cumyl hydroperoxide, benzoyl peroxide, azobisisobutyronitrile, tert-butyl hydroperoxide, potassium persulfate and/or ammonium persulfates, is preferred. This mixture preferably has a glass transition temperature above 40° C.

Suitable polyurethane resins are compounds which contain a terminal isocyanate group which has formed by the reaction of a polyol and an organic polyisocyanate and a chain extender.

Suitable polyols are polyetherpolyols (e.g. obtained by polymerization of an alkylene oxide, such as, for example, ethylene oxides, propylene oxide, styrene oxides or epichlorohydrin) and polyetheresterpolyol, etc.

Suitable polyester polyols and polyetheresterpolyols are obtained by condensation of, for example, saturated or unsaturated polycarboxylic acid or anhydrides, such as, for example, succinic acid, adipic acid, phthalic acid and maleic anhydride, with saturated or unsaturated polyhydric alcohols, such as ethylene glycol, diethylene glycol, 1,4-butanediol, neopentylglycol, 1,6-hexanediol and trimethylolpropane or polyalkylene ether glycols, such as polyethylene glycol and polypropylene glycol.

Suitable organic isocyanates are aromatic diisocyanates, such as isomers of toluidine isocyanate and 4,4-diphenylmethane diisocyanate; aromatic aliphatic diisocyanates, such as xylylene diisocyanate; alicyclic diisocyanates, such as isophorone diisocyanate, 4,4-dicyclohexylmethane diisocyanate; aliphatic diisocyanates, such as hexamethylene diisocyanate and 2,2,4-trimethylhexamethylene diisocyanate and polyisocyanates which are obtained by an addition reaction of the above compounds with trimethylolpropane.

Suitable chain extenders are ethylene glycol, diethylene glycol, 1,4-butanediol and 1,6-hexanediol; polyhydric alcohols, such as glycerol, trimethylolpropane and pentaerythritol; diamines, such as ethylenediamine, hexaethylenediamine and piperazine; amino alcohols, such as monoethanolamines and diethanolamines; thiodiglycol, such as thiodiethylene glycol, and water.

Suitable polyurethanes are Impranil® DLS and DLP from Bayer.

According to the invention, a flameproofed adhesive and sealing material containing 90-99% by weight of polyurethane resins and 1-10% by weight of flameproofing agent is preferred.

Suitable polyester resins contain a dicarboxylic acid component and/or a glycol component and/or a branched glycol component.

Branched glycol components according to the invention are 2,2-dimethyl-1,3-propanediol, 2-methyl-2-ethyl-1,3-propanediol, 2-methyl-2-butyl-1,3-propanediol, 2-methyl-2-propyl-1,3-propanediol, 2-methyl-2-isopropyl-1,3-propanediol, 2-methyl-2-n-hexyl-1,3-propanediol, 2,2-diethyl-1,3-propanediol, 2-ethyl-2-n-butyl-1,3-propanediol, 2-ethyl-2-n-hexyl-1,3-propanediol, 2,2-di-n-butyl-1,3-propanediol, 2-n-butyl-2-propyl-1,3-propanediol and 2,2-di-n-hexyl-1,3-propanediol.

Glycol components according to the invention are ethylene glycol, diethylene glycol, propylene glycol, butanediol, hexanediol, 1,4-cyclohexanedimethanol.

Suitable dicarboxylic acid components are terephthalic acid, isophthalic acid, 2,6-naphthalenedicarboxylic acid, 5-sulfoisophthalic acid, sulfoterephthalic acid; 4-sulfonaphthaleneisophthalic acid, 5-(4-sulfophenoxy)isophthalic acid.

According to the invention, a flameproofed adhesive and sealing material containing 40-99% by weight of polyester resin and 1-60% by weight of flameproofing agent according to the invention is preferred.

Unsaturated polyester resins (UP resins) which are derived from copolyesters of saturated and unsaturated dicarboxylic acids or the anhydrides thereof with polyhydric alcohols and vinyl compounds as crosslinking agents are preferred. UP resins are cured by free radical polymerization with initiators (e.g. peroxides) and accelerators. Preferred unsaturated dicarboxylic acids and derivatives thereof for the preparation of the polyesters are maleic anhydride and fumaric acid. Preferred saturated dicarboxylic acids are phthalic acid, isophthalic acid, terephthalic acid, tetrahydrophthalic acid and adipic acid.

Preferred diols are 1,2-propanediol, ethylene glycol, diethylene glycol and neopentylglycol, ethoxylated or propoxylated bisphenol A. A preferred vinyl compound for crosslinking is styrene.

Preferred curing systems are peroxides and metal coinitiators, e.g. hydroperoxides and cobalt octanoate and/or benzoyl peroxide and aromatic amines and/or UV light and photosensitizers, e.g. benzoin ethers.

Preferred organic peroxides are di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide, dicyclohexyl peroxodicarbonate, cumyl hydroperoxide, p-menthene hydroperoxide, tert-butyl hydroperoxide, diisopropylbenzene dihydroperoxide, methyl ethyl ketone peroxide, tert-butyl peroxobenzoate.

The initiators are preferably used in amounts of from 0.1 to 20% by weight, preferably from 0.2 to 15% by weight, based on the mass of all comonomers.

Preferred metal coinitiators are cobalt, manganese, iron, vanadium, nickel or lead compounds. Metal coinitiators are preferably used in amounts of from 0.05 to 1% by weight, based on the mass of all comonomers.

Preferred aromatic amines are dimethylaniline, dimethyl-p-toluene, diethylaniline and phenyldiethanolamines.

Resins according to the invention which are based on styrene-butadiene contain styrene-butadiene copolymer or an acrylonitrile-butadiene-styrene copolymer or a styrene-ethylene-butadiene-styrene copolymer or a vinylpyridine-styrene-butadiene copolymer.

According to the invention, a flameproofed adhesive and sealing material containing 50-97% by weight of styrene-butadiene resin and 3-50% of flameproofing agent according to the invention is preferred.

Suitable vinyl acetate copolymers are based on esters of vinyl alcohol with a lower carboxylic acid (e.g. vinyl acetate), such as, for example, vinyl acetate-vinylpyrrolidone copolymer, vinyl acetate-acrylate copolymer, 2-ethylhexyl acrylate-vinyl acetate copolymer and ethylene-vinyl acetate copolymer (Elvax® types from DuPont).

Suitable silicones based on silicone rubber have a linear, partly branched or cyclic organopolysiloxane structure which has a main chain which is composed of repeating diorganosiloxane units, such as, for example, dimethylsiloxane or diphenylsiloxane.

Suitable organopolysiloxanes have chain ends of triorganosilyloxy groups, such as the trimethylsilyloxy group, dimethylphenylsilyloxy group, dimethylhydroxysilyloxy group, dimethylvinylsilyloxy group or trivinylsilyloxy group. The average degree of polymerization (weight average) is preferably from 100 to 100 000, in particular from 200 to 10 000.

According to the invention, a flameproofed adhesive and sealing material containing 50-98% by weight of organopolysiloxanes and 2-50% by weight of flameproofing agent is preferred.

Suitable synthetic rubbers are synthetic rubber block copolymers of the ABA or AB block type, A being a thermoplastic block and B an elastomer block. The block copolymer may have a linear, branched or radial structure or combinations thereof. Copolymers preferred according to the invention comprise styrene-isoprene-styrene (SIS), styrene-butadiene-styrene (SBS), styrene-ethylene-butadiene-styrene (SEBS), styrene-butadiene (SB) or ethylene-propylene-dienes. Suitable synthetic rubbers are Kraton® 1107, 1101, 1111, 1112 and 1117 from Shell Chemical Company and Vector® 4100 from Dexco Polymers, Zetpol® 2020 from Zeon Corporation, PNR®-1H from JSR Corporation, Nipol® 1072 from Zeon Corporation.

Suitable acrylate rubbers are copolymers of ethyl acrylate and chloroethyl vinyl ether, copolymers of n-butyl acrylate and acrylonitrile, copolymers of ethyl acrylate and acrylonitrile, urethane-modified acrylate rubbers, styrene-acrylonitrile copolymers and polymers such as methyl methacrylate-acrylonitrile.

A flameproofed adhesive and sealing material containing 50-95% by weight of synthetic rubber and 2-50% by weight of flameproofing agent is preferred.

Suitable epoxy resins are based on diglycidyl ethers, such as, for example, bisphenol A, bisphenol F, bisphenol S, resorcinol, dihydroxynaphthalene and dicyclopentadienediphenol, alicyclic epoxy resins, such as epoxidized phenol novolaks, epoxidized cresol novolaks, epoxidized trisphenylolmethanes, epoxidized tetraphenylolethanes, epoxy resins of the bisphenol type or of the novolak type. Suitable epoxy resins are Epikote® types (phenoxy resins) and YL®7175-1000 from Japan Epoxy Resins, EP®-49-20 from Asahi Denka, EPPN®-502H and EOCN®-103S from Nippon Kayaku.

A flameproofed adhesive and sealing material containing

A) 40-99.8% by weight of epoxy resin
B) optionally phenoxy resin
C) 0.1-10% by weight of curing agent
D) optionally synthetic rubber
E) 0.1-50% by weight of flameproofing agent
is preferred.

Suitable polyolefin resins are polyethylene (e.g. low density polyethylene, linear low density polyethylene, ultralow density polyethylene, medium density polyethylene, high density polyethylene), polypropylene, polybutylene, polybutadiene and copolymers (particularly random copolymers) of ethylene and/or propylene with other alpha olefins, such as, for example, ethylene-propylene copolymers (random copolymer).

Suitable adhesive polymers are crosslinkable or curable by a free radical method, by exposure to UV light or by acids, amines and/or moisture.

Hotmelt adhesives are solvent-free adhesives which are applied in the hot, molten state to the substrates to be adhesively bonded and display their adhesive effect after solidification.

The use of the flameproofed adhesive and sealing materials according to the invention as flameproofed hotmelts is preferred.

Flameproofed adhesive and sealing materials according to the invention contain 50-99% by weight of thermoplastic polymers and 1-50% by weight of flameproofing agent.

The use of flameproofed polymer molding materials containing 50-99% by weight of thermoplastic polymers and 1-50% by weight of flameproofing agent as flameproofed adhesive and sealing material is preferred.

Flameproofed adhesive and sealing materials according to the invention also contain 0.1-60% by weight of thermoplastic polymers, 1-50% by weight of flameproofing agent, 20-65% by weight of resin, 0.1-100% by weight of waxes and 0.1-10% by weight of additives.

A preferred melting range of the thermoplastic polymers is from 100 to 250° C., particularly preferably from 110 to 200° C. This is substantially below the melting range of the flameproofed polymer molding materials based on diethylphosphinic acids according to the prior art.

Suitable thermoplastic polymers are mixtures of epoxy resin, ethylene copolymer, optionally polyester and optionally curing agent.

Suitable epoxy resins are based on bisphenol-A or bisphenol-F, such as, for example, D.E.R® or DERAKANE® from Dow Chemical, and novolac-modified epoxy resins, such as, for example, D.E.N® from Dow Chemical.

Suitable epoxy resins are vinyl ester resins, e.g. reaction products of acrylic acid or methacrylic acid and epoxy resins such as, for example, Derakane® types from Dow Chemical.

Suitable ethylene copolymers are ethylene-acrylic acid copolymers, ethylene-methacrylic acid copolymers, ethylene-vinyl acetate copolymers, ethylene-vinyl acetate-maleic anhydride copolymers, ethylene-acrylate-maleic anhydride copolymers and ethylene-acrylate-glycidyl methacrylate copolymers.

Suitable thermoplastic polymers are organopolysiloxanes having a backbone of diorganopolysiloxy groups where organyl is methyl, ethyl, n-propyl, isopropyl, 1-n-butyl, 2-n-butyl, isobutyl, tert-butyl, n-pentyl, isopentyl, neopentyl, tert-pentyl, n-hexyl, n-heptyl, n-octyl, isooctyl, 2,2,4-triethylpentyl, n-nonyl-, n-decyl-, n-dodecyl-, cyclopentyl, cyclohexyl, cycloheptyl, methylcyclohexyl, phenyl, naphthyl, o-tolyl, m-tolyl, p-tolyl, xylyl, ethylphenyl, benzyl, alpha- and beta-phenylethyl, and of diorganopolysilyloxy groups where organyl is hydrogen, methyl, ethyl, n-propyl, isopropyl, 1-n-butyl, 2-n-butyl, isobutyl, tert-butyl, n-pentyl, isopentyl, neopentyl, tert-pentyl, n-hexyl, n-heptyl, n-octyl, isooctyl, 2,2,4-triethylpentyl, n-nonyl, n-decyl, n-dodecyl, cyclopentyl, cyclohexyl, cycloheptyl, methylcyclohexyl, phenyl, naphthyl, o-tolyl, m-tolyl, p-tolyl, xylyl, ethylphenyl, benzyl or alpha- and beta-phenylethyl radical, monovalent, aliphatically unsaturated hydrocarbon radicals having 2 to 20 carbon atoms (vinyl, allyl, 3-butenyl, 4-pentenyl, 5-hexenyl, 7-octenyl, 9-decenyl and 13-decenyl) and having terminal triorganopolysiloxy groups where organyl is hydrogen, methyl, ethyl, n-propyl, isopropyl, 1-n-butyl, 2-n-butyl, isobutyl, tert-butyl, n-pentyl, isopentyl, neopentyl, tert-pentyl, n-hexyl, n-heptyl, n-octyl, isooctyl, 2,2,4-triethylpentyl, n-nonyl, n-decyl, n-dodecyl, cyclopentyl, cyclohexyl, cycloheptyl, methylcyclohexyl, phenyl, naphthyl, o-tolyl, m-tolyl, p-tolyl, xylyl, ethylphenyl, benzyl or alpha or beta-phenylethyl radical, monovalent, aliphatically unsaturated hydrocarbon radicals having 2 to 20 carbon atoms (vinyl, allyl, 3-butenyl, 4-pentenyl, 5-hexenyl, 7-octenyl, 9-decenyl and 13-decenyl).

Suitable organopolysiloxanes have a backbone of diorganopolysilyloxy groups with 75-85% of dimethylsilyloxy groups and 15-25% of vinylmethylsilyloxy groups.

Suitable thermoplastic polymers are organopolysiloxanes having a backbone of diorganopolysilyloxy groups and having terminal triorganopolysilyloxy groups, it being possible for the organyl groups to carry mercapto, amino, alkenyl, methacryloyloxy, or acryloyloxy groups or alkoxy, acryloyloxyalkyl, epoxy or isocyanurate radicals.

Suitable thermoplastic polymers are polar or nonpolar polymers, in particular atactic poly-alpha-olefins (APAO), polyisobutylene, styrene-butadiene-styrene block polymers, styrene-isoprene-styrene block polymers, polyamides and polyesters.

Suitable thermoplastic polymers are polyvinyl acetate plastomers.

Suitable thermoplastic polymers are copolyesters, such as, for example, compositions copolymerized in ABA three-block segments and comprising hydroxyl-terminated polyalkylene oxide (Block A) and polydimethylsiloxane as Block B.

Suitable copolyesters contain a block having a low polarity incorporated into the copolyester backbone. The block having a low polarity is incorporated together with difunctional alcohols, dicarboxylic acids and optionally polyfunctional branching agents in the form of polymerized units.

Suitable difunctional alcohols are C₂₋₁₂-alkyldiols, such as, for example, ethylene glycol, diethylene glycol, butanediol, propanediol and hexanediol.

Suitable dicarboxylic acids are aliphatic C₄₋₃₆-dioic acids, such as adipic acid, azelaic acid, sebacic acid, terephthalic acid, isophthalic acid and naphthalene dicarboxylic acid.

Suitable polyfunctional branching agents are trimellitic anhydride, pyromellitic dianhydride, trimethylolethane, trimethylolpropane, pentaerythritol.

Suitable blocks having a low polarity are hydroxyl-terminated butylene-ethylene copolymers (e.g. Kraton® L-2203, from Shell) and hydroxyl-terminated ABA three-block polysiloxane (CoatOsil® 2812 from Witco).

Suitable thermoplastic polymers are butyl rubbers based on from 20 to 100% of styrene-butadiene-styrene or styrene-isoprene-block polymers, to which from 0 to 50% of a thermoplastic polymer, e.g. polyisobutylene, is added.

Suitable thermoplastic polymers are ternary and quaternary copolyamides; also polyamides whose amide bonds are on average at least fifteen carbon atoms apart and which have an amorphous structure, consisting of dicarboxylic acids, such as adipic acid, azelaic acid, sebacic acid, suberic acid, succinic acid, glutaric acid, isophthalic acid, terephthalic acid, dimeric fatty acids, and diamines, such as ethylenediamine, 1,3-diaminopropane, hexamethylenediamine, methylpentamethylenediamine, trimethylhexamethylenediamine, 9-aminomethylstearylamine, 10-aminoethylstearylamine, 1,3-di-4-piperidylpropane, diaminodicyclohexylmethane, methylenedianiline, bis(aminoethyl)diphenyl oxide, dimeric fatty acid diamines and ether diamines.

Suitable thermoplastic polymers contain 10-50% of thermoplastic polyamide, 10-75% of ethylene-vinyl acetate copolymer or ethylene-n-butyl acrylate-methacrylic terpolymer, 5-50% of thermoplastic epoxy resin (bisphenol A-based resins, epoxy-cresol resin and polyfunctional epoxy resins having epoxide numbers of from 200 to 4 000 mmol/kg).

Suitable thermoplastic polymers are polyurethanes, for example mixtures of two amorphous polyurethane prepolymers which differ with respect to their glass transition temperature. Polyurethanes are prepared from polyols and isocyanates. Suitable polyols are copolymers that have aromatic and/or aliphatic carboxylic acids and low molecular weight diols. Suitable carboxylic acids are isophthalic acid or terephthalic acid. Suitable diols are ethylene glycol, butanediol, hexanediol, etc. A suitable isocyanate is 4,4′-diphenyl diisocyanate. The ratio of the number of NCO to the number of OH is preferably from 1.1 to 6.0. The polyol may be a linear or weakly crosslinked polyester or polyether or another polymer terminated by hydroxyl groups. The glass transition temperature is preferably from −30° C. to 20° C.

Suitable resins improve the adhesive effect and may have a compatibility-imparting effect on the various adhesive components.

Waxes are used for modification. Preferred waxes are macrocrystalline and microcrystalline paraffin waxes, Fischer-Tropsch waxes and polyolefin waxes. Polyolefin waxes prepared with the aid of metallocene catalysts and/or isotactic polypropylene polymers are preferred.

Preferred polyolefin waxes have a drop point or softening point of from 80 to 165° C., a melt viscosity of not more than 40 000 mPa s, a melt flowrate of from 1 to 500 g/10 min and a weight average molar mass Mw of from 1 000 to 30 000 g/mol.

Suitable waxes are copolymer waxes of propylene and from 0.1 to 30% by weight of ethylene and/or from 0.1 to 50% by weight of at least one branched or straight-chain 1-alkene having 4 to 20 carbon atoms, which have a melt viscosity of from 100 to 30 000 mPa s, propylenehomopolymer waxes having a melt viscosity of from 100 to 30 000 mPa s, ethylenehomopolymer waxes, copolymer waxes of ethylene and 0.1-30% by weight of at least one branched or straight-chain 1-alkene, having 3 to 20 carbon atoms. Olefin homo- and copolymer waxes may be modified so as to be polar and/or may be oxidized.

Suitable isotactic polypropylenepolymers comprise a random copolymer of propylene and an alpha-olefin having the formula R—CH═CH₂ in which R is H or a C₂₋₁₀-alkyl group, preferably ethylene.

Suitable resins are rosins and derivatives thereof or hydrocarbon resins. Suitable rosins are disproportionated, dehydrogenated and/or partly hydrogenated, dimerized rosin, rosin adducts, rosin esters, rosin adduct esters. Suitable resins are aliphatic, cycloaliphatic, aromatic hydrocarbon resins (Piccotac® 95 from Eastman Chemical Company, Escoreze® 1310LC, from ExxonMobil Chemical Company), terpene resins, phenol-modified terpene resins and/or methyl abietate

Additives for hotmelts are plasticizers, nucleating agents, crosslinking agents, pigments, antioxidants, fillers and surfactants. Fillers are talc, calcium carbonate, clay, silica, mica, wollastonite, feldspar, aluminum silicate, alumina, aluminum hydroxide, glass beads, ceramic beads, barite, and woodflour. Surfactants are fatty acid esters, alcohol ethoxylates and ethylene oxide/propylene oxide copolymers.

The invention also relates to a process for the preparation of the flameproofed adhesive and sealing materials according to the invention, wherein the flameproofing agent according to the invention and polymer are mixed with one another.

In the process for the preparation of flameproofed adhesive and sealing materials according to the invention, a) at least one component is initially introduced in the molten state, b) the further component is admixed, c) the mixture is optionally cooled, and d) the mixture is extrudated or pelletized.

The preferred processing temperature is from 20 to 300° C., in particular from 50 to 200° C.

The preferred pressure for the processing is from 10 to 100 000 000 Pa.

The preferred reaction time is from 0.1 to 100 h, particularly preferably from 1 to 10 h.

Mixing is preferably effected in stirred tanks, kneaders, solids mixers, roll mills or extruders.

Suitable mixing members in the case of stirred tanks are anchor stirrers, paddle stirrers, multistage impulse countercurrent agitators, propeller stirrers, impeller stirrers, turbine stirrers, cross stirrers, disperser discs, hollow (gassing) stirrers, rotor-stator mixers, static mixers, venturi nozzles and/or airlift pumps.

Suitable mixers are plowshare mixer types from Lödige, annular-gap mixer types from Lödige, (e.g. type CB30), Flexomix mixer types from Schugi, annular-gap mixer type HEC from Niro, annular-bed mixers (e.g. type K-TTE4) from Drais, Mannheim, Eirich mixers (e.g. type R02), Telschig mixers (type WPA6), Hauf mixers (the last two operate according to the gravity principle), Zig-Zag mixers from Niro and mixers from Nauta in which the material to be mixed is circulated according to the Archimedes principle by means of a screw.

Mixing in roll mills is preferably effected in three-roll mills and in mixers of the Werner & Pfleiderer type or Banbury mixers under the action of high shear forces.

Suitable extruders or compounding units are single-screw extruders or twin-screw extruders of the ZSK types from Krupp Werner & Pfleiderer, products from Leistritz, Compex® types, BTS 40 types (Betol Machinery Ltd). Suitable kneaders are, for example, all-phase mixing and kneading apparatuses, single- and twin-screw mixers, heating mixers, kneader-mixers, cooling mixers from List, Switzerland, mixer-kneaders of the MDK type from Buss, Switzerland.

Moldings according to the invention which contain the preferred flameproofed adhesive and sealing material are laminates consisting of a nontacky substrate layer and one or more adhesive layers. At least one of the layers contains the flameproofed adhesive and sealing materials according to the invention.

Moldings according to the invention are adhesive tapes having one or more adhesive layers, at least one of which contains the flameproofed adhesive and sealing material according to the invention and give a one-sided or double-sided adhesive tape.

In water-resistant adhesive tape according to the invention, two nontacky layers are bonded by a flameproofed adhesive and sealing material.

Moldings according to the invention consist of a glass fabric-reinforced copper-clad epoxide-based substrate, solder resist and flameproofed adhesive and sealing materials.

Moldings according to the invention consist of a flexible copper-clad substrate, solder resist and flameproofed adhesive and sealing material.

Moldings according to the invention consist of a copper-clad polyimide film, solder resist and flameproofed adhesive and sealing material.

According to the invention, a thickness of the nontacky substrate layer, copper-clad substrate, flexible copper-clad substrate circuit board, copper-clad polyimide film and/or solder resist of from 10⁻⁹ to 10⁻¹ m is preferred.

According to the invention, a thickness of the flameproofed adhesive and sealing material layer of from 10⁻⁹ to 10⁻² m is preferred.

According to the invention, the ratio of the thicknesses of nontacky substrate layer, copper-clad substrate, flexible copper-clad substrate circuit board, copper-clad polyimide film and/or solder resist to the thickness of the flameproofed adhesive and sealing material layer is preferably from 1 000:1 to 1:1 000.

The invention also relates to a process for the production of moldings, wherein the flameproofed adhesive and sealing material is applied to a substrate film, a copper layer is pressed on and curing is effected. The substrate film preferably comprises polyimide.

In a further process for the production of moldings, the flameproofed adhesive and sealing material is applied to a substrate layer and cured by exposure to light. The substrate film preferably comprises polyester.

In another process for the production of flameproofed pressure-sensitive adhesive tapes, the flameproofed adhesive and sealing material is laminated with a substrate film. The substrate film preferably comprises polyethylene terephthalate.

The invention also comprises a process for the production of an electric cable, wherein polyester is extruded to give a nontacky 100 μm substrate layer and flameproofed adhesive and sealing material is applied and a pair of these layers is hot-pressed onto the top and bottom of electrical conductor tracks.

The invention also comprises a process for the production of double-sided adhesive tape, wherein a substrate material is coated on both sides with flameproofed adhesive and sealing material.

In a process for the production of an adhesive tape, in the case of a one-sided adhesive tape, the substrate side facing away from the adhesive is coated with wax by passing the substrate through a pair of rolls comprising a high-speed (1 000-1 500 rpm) roll heated to 100 to 200° C. and a cold, soft, low-speed opposite roll.

Processes for coating substrates by means of rolls, by contact coating with a melt nozzle, contactless coating with a melt nozzle, extrusion coating with a T-nozzle, fishtail die or bow die are preferred.

Suitable substrate layers are based on silicone rubber, polyurethane, polyurethane foam, rubber, polyacrylate, mortar, concrete, ceramic, porcelain, stoneware, enamel and glass, metals, such as iron, steel, aluminum and copper, brass, cast iron, paper, wood, polyvinyl chloride, polyesters (e.g. PET, polyethylene naphthalate PEN, polybutylene terephthalate), polyamide, polyimide (Kapton® 100H), aramid, polycarbonates, polystyrene, styrene block copolymers, polymethyl methacrylate, polyvinylidene fluoride (Kynar®), oriented polypropylene, polyvinyl fluoride (Tedlar®), glass fiber reinforced epoxy resins or cellulose.

The invention also comprises substrate layers based on fibers, nonwovens and woven fabrics of said materials, woven fabrics and non wovens of mineral fibers, metal fibers or plastic fibers. The invention also comprises substrate layers based on substrate sheets comprising siliconized fluorinated sheets having a release action, and on substrate sheets comprising BOPP, MOPP, PVC, PE/EVA or EPDM.

Finally, the invention also relates to the use of the flameproofed adhesive and sealing material as claimed in one or more of claims 1 to 14 and/or of the moldings as claimed in one or more of claims 15 to 19 for flat cables, flexible circuit boards, interior automotive trim, electrical semiconductors, covering layers, optical films for the protection of windows from sunlight, circuit boards, optical conductors, coils for demagnetization, for the fixing of electrical assemblies, for the production of electrical insulation materials, medium- and high-voltage insulators, cable terminal boxes, cable sleeves, for the potting or embedding of electrical or electronic or photovoltaic assemblies, for sealing, for the production of coatings, for the insulation of electrical conductors and for the adhesive bonding and lamination of the abovementioned substrates, diapers, hospital hygiene articles, feminine hygiene articles, operating theatre requisites, incontinence articles, adhesive bonding of cardboard packaging, packaging materials, adhesive tapes, labels, insulating glass panes, adhesive bonds of pipes or injection molded parts, contact adhesive materials, flexible adhesive bonds of printed circuit boards, heat-activatable contact adhesive tapes, for the potting of electrical or electronic components, as heat-curing epoxy molding compounds (EMC).

Epoxy hotmelt adhesive materials according to the invention give peel resistances of from 4 to 10 N/mm in the angle peel test.

Silicone-based hotmelt adhesive materials according to the invention give adhesion values of from 10 to 100 N/5 cm in the adhesion test.

Polypropylene hotmelt adhesive materials according to the invention give peel resistance values of from 5 to 40 g/mm in the 180° peel test.

Polyamide hotmelt adhesive materials according to the invention give peel resistance values of from 0.1 to 10 N/mm in the angle peel test.

Hotmelt adhesive materials according to the invention based on ethylene-vinyl acetate resin give peel resistance values of from 0.1 to 4 N/mm.

Flameproofed adhesive and sealing materials according to the invention (adhesive polymer and flameproofing agent) give peel resistances of 0.1-10 N/mm in the angle peel test and peel resistances of 0.1 to 10 N/mm in the 1800 peel test.

### EXAMPLE 1

### Comparison

Epoxy hotmelt adhesive materials according to the invention are prepared by kneading 75% of epoxy resin (DER® 662, from Dow Chemical), 10% of ethylene copolymer (Lotader® AX8900, from Elf-Atochem), 10% polyester resin (Tone® 767, from Union Carbide) and 5% of curing agent (Dyhard® 100S, from Degussa) in a twin-screw extruder at a melt temperature of from 110 to 120° C. during a residence time of less than two minutes and then processing the mixture to give 2-3 mm pellets by means of an underwater granulator. UL-94 test bars having a thickness of 1.6 mm are produced as injection moldings from the material. The test results are shown in table 1.

Other moldings can be produced by melting the flameproofed adhesive and sealing material at about 100° C. and applying it to metal surfaces in order to adhere there.

The angle peel test is carried out on two degreased steel samples by adhesively bonding them by means of a 1 to 1.5 mm thick, 25 mm wide and 100 mm long adhesive film and then effecting curing for 25 min at 200° C. The adhesive layer is 0.5 mm thick. At a traversing speed of 10 mm/min, a peel resistance of 6.8 N/mm is determined.

### EXAMPLE 2

### Comparison

A flameproofed adhesive and sealing material (epoxy hotmelt adhesive materials) comprising 10% of ammonium polyphosphate (P®-30 Regular Degree, from Astaris, decomposition from 250° C.), 67.5% of epoxy resin, 9% of ethylene copolymer, 9% of polyester resin and 4.5% of curing agent is prepared by the same process as described in example 1, and UL-94 test bars having a thickness of 1.6 mm are produced as injection moldings. In the climatic test (80° C. at 95% relative humidity), strong white blooming occurs.

### EXAMPLE 3

A flameproofed adhesive and sealing material (epoxy hotmelt adhesive material) comprising 10% of diethyl phosphinate 1, 67.5% of epoxy resin, 9% of ethylene copolymer, 9% of polyester resin and 4.5% of curing agent is prepared by the same process as described in example 1, and UL-94 test bars having a thickness of 1.6 mm are produced as injection moldings. The test results are shown in table 1. In the climatic test (80° C. at 95% relative humidity), no blooming is observed. Other moldings can be produced by melting the flameproofed adhesive and sealing material at about 100° C. and applying it to metal surfaces in order to adhere there.

The angle peel test is carried out on two degreased steel samples. A peel resistance of 5.7 N/mm is determined.

### EXAMPLE 4

### Comparison

Mixture 1: 2 600 g of an alpha,omega-divinylpolydimethylsiloxane are thoroughly worked in a kneader (from Werner & Pfleiderer) at 25° C. After a kneading time of 20 min, 4.2 g of a divinyltetramethylplatinum complex having a platinum content of 1% by weight are added and kneading is effected for 15 min. Thereafter 2.05 g of ethynylcyclohexanol and 58 g of silane (EtO)₃Si—CH₂CH₂CH₂-cyclo-(—CH—CO—O—CO—CH₂—) are added and kneading is effected for a further 15 min.

Mixture 2: 2 530 g of an alpha,omega-divinylpolydimethylsiloxane are thoroughly worked in a kneader (from Werner & Pfleiderer) at 25° C. After 30 min, 876 g of a siloxane of the formula Me₃SiO(Me₂SiO)₉₀(HMeSiO)₃₀SiMe₃ are added and kneading is effected for a further 15 min. After addition of 0.5 g of ethynylcyclohexanol, kneading is effected for the duration of 15 min.

Mixtures 1 and 2 are mixed in the weight ratio of one to one and vulcanized in 5 min at 170° C. to give sheet-like moldings of a flameproofed adhesive and sealing material (hotmelt adhesive material) of 1.6 mm thickness. UL-94 test bars are cut out therefrom as moldings. The test results are shown in table 1. The adhesion test of adhesively bonded 25 mm wide and 150 mm long woven polyester fabrics using a tensile tester at 100 mm/min feed rate gives an adhesion value of 64 N/5 cm.

### EXAMPLE 5

A hotmelt adhesive material is prepared by the process described in example 4, by incorporating 31 g of diethyl phosphinate 2 in small portions initially into 2 600 g of alpha,omega-divinylpolydimethylsiloxane for mixture 1 and continuing the procedure analogously. For mixture 2, 31 g of diethyphosphinate 2 are incorporated in small portions into 2 530 g of alpha,omega-divinylpolydimethylsiloxane and the procedure is continued analogously. The test results are shown in table 1. The adhesion test of adhesively bonded woven polyester fabrics gives an adhesion value of 58 N/5 cm.

### EXAMPLE 6

### Comparison

In a stirred laboratory reactor having a heating jacket and thermometer, 30% of atactic homopolypropylene (Elastoflex® P1010, from Eastman Chemical), 10% of liquid aliphatic C₅-hydrocarbon resin (Wingtack® 10, from Goodyear Chemicals), 46.5% of aliphatic C₅-hydrocarbon resin (Hercotac® 1148, from Eastman Chemical), 5% of mineral oil plasticizer (Nyplast® 222B, from Nysas Canada Inc) and 0.5% of antioxidant (Irganox® 1010, from Ciba SC) are heated to 175-190° C. under an inert gas atmosphere and, after melting of the components, are stirred. Thereafter, 8% of isotactic propylene-ethylene copolymer (EOD®01-06, from AtoFina Petrochemicals) are added and thoroughly mixed in. 2 kg of flameproofed adhesive and sealing material (polypropylene hotmelt adhesive material) are obtained. Sheet-like moldings of 1.6 mm thickness are cast therefrom and UL-94 test bars are cut out as moldings. The test results are shown in table 1. In the 1800 peel test, a peel resistance of 16.2 g/mm is measured on a test specimen comprising a 1 mm thick PE film and a polypropylene nonwoven at a traversing speed of 30 cm/min. Other moldings can be produced by coating elastic strips comprising Lycra® 740, polyethylene film, or polypropylene spunbond or corrugated board with the material.

### EXAMPLE 7

2 kg of flameproofed adhesive and sealing material (polypropylene hotmelt adhesive material) are obtained from 30% of diethyl phosphinate 2, 21% of atactic homopolypropylene, 7% of liquid aliphatic C₅-hydrocarbon resin, 32.6% of aliphatic C₅-hydrocarbon resin, 3.5% of mineral oil plasticizer, 0.4% of antioxidant and 5.5% of isotactic propylene-ethylene copolymer by the process described in example 6. Sheet-like moldings of 1.6 mm thickness are cast therefrom, and UL-94 test bars are cut out as moldings. The test results are shown in table 1. In the 180° peel test, a peel resistance of 14.8 g/mm is measured. Other moldings can be produced by coating elastic strips comprising Lycra® 740, polyethylene film, or polypropylene spunbond or corrugated board with the material.

### EXAMPLE 8

### Comparison

In a stirred laboratory reactor having a heating jacket and thermometer, 10% of mineral oil plasticizer (Pennznap®500, from Pennzoil Products), 15% of synthetic polyethylene wax (Marcus® 300, Marcus Oil & Chemicals) and 44% of hydrogenated aliphatic C₅-hydrocarbon resin (Eastotac® H100W, Eastman Chemical Company) pre heated to 190° C. under an inert gas atmosphere and, after melting of the components, are stirred. Thereafter, 30% of flexible polypropylene homopolymer (RexFlex® W121) are added and thoroughly mixed in. 2 kg of flameproofed adhesive and sealing material (polypropylene hotmelt adhesive material) are obtained, and sheet-like moldings of 1.6 mm thickness are cast therefrom and UL-94 test bars are cut out as moldings. The test results are shown in table 1.

In the 180° peel test, a peel resistance of 23.2 g/mm is measured on a test specimen comprising a 1 mm thick PE film and a polypropylene nonwoven at a traversing speed of 30 cm/min. Other moldings can be produced by coating elastic strips comprising Lycra® 740, polypropylene nonwoven or polyethylene film or corrugated board with the material.

### EXAMPLE 9

2 kg of flameproofed adhesive and sealing material (polypropylene hotmelt adhesive material) are obtained from 30% of diethyl phosphinate 2, 7% of mineral oil plasticizer, 15% of synthetic polyethylene wax, 31.5% of hydrogenated aliphatic C₅-hydrocarbon resin and 21% of flexible polypropylene homopolymer via the process described in example 8, and sheet-like moldings of 1.6 mm thickness are cast therefrom and UL-94 test bars are cut out as moldings. The test results are shown in table 1. In the 180° peel test, a peel resistance of 25.5 g/mm is measured. Other moldings can be produced by coating elastic strips comprising Lycra® 740, polypropylene nonwoven or polyethylene film or corrugated board with the material.

### EXAMPLE 10

### Comparison

31.5% of polyamide (Macromelt® 6301, from Henkel), 3.5% of copolyamide (Eurelon® 100, from Huntsman), 35% of ethylene-n-butyl acrylate-methacrylic acid terpolymer (BYNEL® CXA 2002, from DuPont) and 30% of epoxy resin (Epicote® 1004, Shell Chemie) are cryogenically milled and passed through a sieve having a diameter of 300 μm. Oversize is recycled to the milling. Sheet-like moldings of 1.6 mm thickness are cast from 2 kg of the flameproofed adhesive and sealing material (polyamide hotmelt adhesive material) and UL-94 test bars are cut out as moldings. The test results are shown in table 1. In the angle peel test, a peel resistance of 3.4 N/mm is measured on a polyethylene test specimen with a 6.25 cm wide, 12.5 cm long and 0.625 mm thick adhesive surface and a traversing speed of 5 cm/min.

### EXAMPLE 11

2 kg of flameproofed adhesive and sealing material (polyamide hotmelt adhesive material) are obtained from 20% of diethyl phosphinate 2, 25.2% of polyamide, 2.8% of copolyamide, 28% of ethylene-n-butyl acrylate-methacrylic acid terpolymer and 24% of epoxy resin by the process described in example 10, and sheet-like moldings of 1.6 mm thickness are cast and UL-94 test bars are cut out as moldings. The further test results are shown in table 1. In the angle peel test, a peel resistance of 3.6 N/mm is measured.

### EXAMPLE 12

### Comparison

A flameproofed adhesive and sealing material (hotmelt adhesive material) is prepared by melting 47.3% of ethylene-vinyl acetate resin (Elvax®, from DuPont), 47.3% of dehydrated/partly hydrated rosin (Resin® 835A, Abieta Chemie GmbH), 5% of propylene-ethylene copolymer wax prepared using metallocene (from Clariant) and 0.4 g of antioxidant (Hostanox® O 10, from Clariant) in a beaker and stirring them for one hour at 180° C. Sheet-like moldings of 1.6 mm thickness are cast therefrom and UL-94 test bars are cut out as moldings. The further test results are shown in table 1.

In the angle peel test, a peel resistance of 1.4 N/mm is measured on a 25 cm long and 1 cm wide aluminum test specimen. Other moldings can be produced by coating aluminum foils with the flameproofed adhesive and sealing material and adhesively bonding them.

### EXAMPLE 13

A flameproofed adhesive and sealing material (hotmelt adhesive material) is prepared from 30% of diethyl phosphinate 3, 33.1% of ethylene-vinyl acetate resin, 33.1% of dehydrated/partly hydrated rosin, 3.5% of propylene-ethylene copolymer wax prepared using metallocene and 0.3% of antioxidant by the process as described in example 12. Sheet-like moldings of 1.6 mm thickness are cast therefrom and UL-94 test bars are cut out as moldings. The test results are shown in table 1. In the angle peel test, a peel resistance of 1.3 N/mm is measured.

### EXAMPLE 14

A flameproofed adhesive and sealing material (hotmelt adhesive material) is prepared from 4.75% of diethyl phosphinate 1, 0.25% of diethyl phosphinate 3, 44.9% of ethylene-vinyl acetate resin, 44.9% of dehydrated/partly hydrated rosin, 4.8% of propylene-ethylene copolymer wax prepared using metallocene and 0.4% of antioxidant via the process as described in example 12. Sheet-like moldings of 1.6 mm thickness are cast therefrom and UL-94 test bars are cut out as moldings. The test results are shown in table 2. In the angle peel test, a peel resistance of 1.7 N/mm is measured.

### EXAMPLE 15

A hotmelt adhesive material is produced by the process described in example 4, by incorporating 683 g of diethyl phosphinate 2 and 76 g of zinc borate in small portions initially into 2 600 g of alpha,omega-divinylpolydimethylsiloxane for mixture 1 and continuing the procedure analogously. For mixture 2, 683 g of diethyl phosphinate 2 and 76 g of zinc borate are incorporated in small portions into 2 530 g of alpha,omega-divinylpolydimethylsiloxane and the procedure is continued analogously. The test results are shown in table 2. The adhesion test of adhesively bonded woven polyester fabrics gives an adhesion value of 65 N/5 cm.

### EXAMPLE 16

A flameproofed adhesive and sealing material (epoxy melt adhesive material) is prepared from 16% of diethyl phosphinate 2, 4% of boron phosphate, 60% of epoxy resin, 8% of ethylene copolymer, 8% of polyester resin and 4% of curing agent by the same process as described in example 1, and UL-94 test bars of 1.6 mm thickness are produced as injection moldings. The further test results are shown in table 2.

The angle peel test is carried out on two degreased steel samples. A peel resistance of 6.2 N/mm is determined. Other moldings can be produced by melting the flameproofed adhesive and sealing material at about 100° C. and applying it to metal surfaces in order to adhere there.

### EXAMPLE 17

2 kg of flameproofed adhesive and sealing material (polypropylene hotmelt adhesive material) are obtained from 7% of diethyl phosphinate 2, 3% of melamine polyphosphate, 9% of mineral oil plasticizer, 13.5% of synthetic polyethylene wax, 40.5% of hydrogenated aliphatic C₅-hydrocarbon resin and 27% of flexible polypropylene homopolymer by the process described in example 8, and sheet-like moldings of 1.6 mm thickness are cast therefrom and UL-94 test bars are cut out as moldings. The test results are shown in table 2. In the 180° peel test, a peel resistance of 18.7 g/mm is measured. Other moldings can be produced by coating elastic strips comprising Lycra® 740, polypropylene nonwoven or polyethylene film or corrugated board with the material.

### EXAMPLE 18

A flameproofed adhesive and sealing material (epoxy hotmelt adhesive material) is prepared from 12% of diethyl phosphinate 2, 8% of melamine cyanurate, 15% of epoxy resin, 2% of ethylene copolymer, 2% of polyester resin and 1% of curing agent by the same process as described in example 1, and UL-94 test bars of 1.6 mm thickness are produced as injection moldings. The further test results are shown in table 2. The angle peel test is carried out on two degreased steel samples. A peel resistance of 5.6 N/mm is determined. Other moldings can be produced by melting the flameproofed adhesive and sealing material at about 100° C. and applying it to metal surfaces in order to adhere there.

### EXAMPLE 19

A flameproofed adhesive and sealing material (hotmelt adhesive material) is prepared from 15% of diethyl phosphinate 2, 15% of aluminum phosphate, 33.1% of ethylene-vinyl acetate resin, 33.1% of dehydrated/partly hydrated rosin, 3.5% of propylene-ethylene copolymer wax prepared using metallocene and 0.3% of antioxidant by the process as described in example 12. Sheet-like moldings of 1.6 mm thickness are cast therefrom and UL-94 test bars are cut out as moldings. The further test results are shown in table 2. In the angle peel test, a peel resistance of 1.3 N/mm is measured.

### EXAMPLE 20

2 kg of flameproofed adhesive and sealing material (polypropylene hotmelt adhesive material) are obtained from 3% of diethyl phosphinate 1, 27% of piperazine pyrophosphate, 21% of atactic homopolypropylene, 7% of liquid aliphatic C₅-hydrocarbon resin, 32.6% of aliphatic C₅-hydrocarbon resin, 3.5% of mineral oil plasticizer, 0.4% of antioxidant and 5.5% of isotactic propylene-ethylene copolymer by the process described in example 6. Sheet-like moldings of 1.6 mm thickness are cast therefrom and UL-94 test bars are cut out as moldings. The test results are shown in table 2. In the 1800 peel test, a peel resistance of 15.1 g/mm is measured. Other moldings can be produced by coating elastic strips comprising Lycra® 740, polyethylene film, or polypropylene spunbond or corrugated board with the material.

### EXAMPLE 21

2 kg of flameproofed adhesive and sealing material (polyamide hotmelt adhesive material) are obtained from 12% of diethyl phosphinate 2, 1% of zinc borate, 7% of melamine polyphosphate, 25.2% of polyamide, 2.8% of copolyamide, 28% of ethylene-n-butyl acrylate-methacrylic acid terpolymer and 24% of epoxy resin by the process described in example 10, and sheet-like moldings of 1.6 mm thickness are cast and UL-94 test bars are cut out as moldings. The test results are shown in table 2.

In the angle peel test, a peel resistance of 3.4 N/mm is measured.

### EXAMPLE 22

2 kg of flameproofed adhesive and sealing material (polypropylene hotmelt adhesive material) are obtained from 16.25% of diethyl phosphinate 1, 6.25% of melamine polyphosphate, 2.5% of zinc oxide, 22.5% of atactic homopolypropylene, 7.5% of liquid aliphatic C₅-hydrocarbon resin, 34.8% of aliphatic C₅-hydrocarbon resin, 3.8% of mineral oil plasticizer, 0.4% of antioxidant and 6% of isotactic propylene-ethylene copolymer by the process described in example 6. Sheet-like moldings of 1.6 mm thickness are cast therefrom and UL-94 test bars are cut out as moldings. The test results are shown in table 2.

In the 180° peel test, a peel resistance of 16.3 g/mm is measured. Other moldings can be produced by coating elastic strips comprising Lycra® 740, polyethylene film or polypropylene spunbond or corrugated board with the material.

### EXAMPLE 23

A flameproofed adhesive and sealing material (hotmelt adhesive material) is prepared from 14% of diethyl phosphinate 1, 14% of melamine polyphosphate, 30.7% of ethylene-vinyl acetate resin, 30.7% of dehydrated/partly hydrated rosin, 3.3% of propylene-ethylene copolymer wax prepared using metallocene and 0.3% of antioxidant by the process as described in example 12. Sheet-like moldings of 1.6 mm thickness are cast therefrom and UL-94 test bars are cut out as moldings. The test results are shown in table 2.

In the angle peel test, a peel resistance of 1.3 N/mm is measured.

### EXAMPLE 24

22% by weight of a terpolymer, which in turn consists of 94% by weight of isooctyl acrylate, 6% by weight of acrylic acid and 0.25% by weight of 2,3-epoxypropyl methacrylate, 15% by weight of diethyl phosphinate 2, 7% by weight of melamine polyphosphate, 11% by weight of titanium dioxide and 67% by weight of a mixture of heptane and ethyl acetate are wet-milled. The flameproofed adhesive and sealing material is applied as a coat to a 25 μm thick PET substrate film and dried for 5 min at 110° C. The application of flameproofed adhesive and sealing material (adhesive polymer and flameproofing agent) is 50 g/m² after drying. An adhesive tape is obtained by cutting to size and rolling up. Sheet-like moldings of 1.6 mm thickness are cast from the flameproofed adhesive and sealing material and UL-94 test bars are cut out as moldings. The test results are shown in table 3. The peel resistance is 40 g/mm.

### EXAMPLE 25

7% by weight of natural rubber (from Goodyear), 4.4% by weight of resin (Piccolyte® S115, from Hercules), 0.7% of zinc resinate (Zirex®, from Reichhol Chem), 0.8% by weight of phenol resin (UCAR® CK 1634, from Union Carbide), 0.1% by weight of antioxidant (Irganox® 1010, from Ciba Geigy), 1% by weight of titanium dioxide (Titanox® 2020, from NL Industries), 2% by weight of diethyl phosphinate 2 and 84% by weight of toluene are dispersed in a ball mill for 2 h. The flameproofed adhesive and sealing material (adhesive polymer and flameproofing agent) is then applied by knife-coating to a 30 μm thick PET film and then dried in an oven at 90° C. for 8 min. Sheet-like moldings of 1.6 mm thickness are cast from the flameproofed adhesive and sealing material and UL-94 test bars are cut out as moldings. The test results are shown in table 3.

In the angle peel test with an aluminum test specimen, a peel resistance of 0.4 N/mm is measured.

### EXAMPLE 26

A homogeneous suspension of 9.0% by weight of diethyl phosphinate 3, 11.4% by weight of styrene-isoprene-styrene block copolymer (Kraton® 1107CS, from Shell), 15.3% by weight of resin 1 (Escorez® 1310, from Exxon), 7.6% by weight of resin 2 (Zonarez® Alpha 24, from Arizona Chemical), 0.3% by weight of antioxidant (Irganox® 1076, from Ciba SV), 17.7% by weight of toluene and 38.7% by weight of heptane is prepared by stirring the components for 1 min at 150 rpm and for 24 h at 200 rpm. A release film is coated with the solution of the flameproofed adhesive and sealing material (adhesive polymer and flameproofing agent) and dried at first for 5 min at 30° C. and then for 15 min at 80° C. in a circulation oven. The flameproofed adhesive and sealing material is pressed between a 2 mm thick, 70 mm wide and 30 mm long test specimen comprising polyethylene foam and a 25 μm thick aluminum foil.

Sheet-like moldings of 1.6 mm thickness are cast from the solution of the flameproofed adhesive and sealing material and UL-94 test bars are cut out as moldings. The test results are shown in table 3. In the 1800 peel test, a peel resistance of 1.6 N/mm is measured.

### EXAMPLE 27

3.5% by weight of natural rubber (Cariflex® IR, from Shell), 1.9% by weight of styrene-butadiene rubber (Cariflex® S, from Shell), 15% by weight of diethyl phosphinate 2, 6.6% by weight of resin, (Escorez® 1304, from Exxon Chemicals) and 0.3% by weight of antioxidant (Irganox® 1076, from Ciba SV) are dissolved in 72.7% by weight of toluene to give a solution 1.

2.9% by weight of natural rubber (Cariflex® IR, from Shell), 1.3% by weight of styrene-butadiene rubber (Cariflex S, from Shell), 16% by weight of diethyl phosphinate 2, 5.0% by weight of resin (Escorez® 1304, from Exxon Chemicals), 0.4% by weight of antioxidant (Irganox® 1076, from Ciba SV) and 0.04% by weight of Titanox 2020 titanium dioxide pigment (from NL Industries) are dissolved in 74.36% by weight of toluene to give a solution 2.

A woven acetate fabric having warp threads of 83 dtex and 180 threads/inch and weft threads of 166 dtex and 53 threads/inch was first impregnated with an amount of solution 1 such that 12 gb/m² of active substance are applied. Solution 2 is then applied in an amount such that additionally 200 g of active substance of adhesive polymer are applied on drying.

The woven fabric is rolled up and cut into rolls of 12 mm width and gives a flameproofed adhesive tape.

Sheet-like moldings of 1.6 mm thickness are cast from solutions 1 and 2 of the flameproofed adhesive and sealing material (adhesive polymer and flameproofing agent) and UL-94 test bars are cut out as moldings. The test results are shown in table 3.

In the angle peel test on a test specimen, a peel resistance of 6.8 N/12 mm is measured.

### EXAMPLE 28

A solution of 20% by weight of styrene-isoprene-styrene three-block polymer (type Kraton® 1107 S-1-S, from Shell), 4% by weight of diethyl phosphinate 2 (from Clariant), 0.2% by weight of antioxidant (Irganox® 1010, from Ciba SV), 16.1% by weight of olefin resin (Escorez® 1304 from Exxon), 4% by weight of polystyrene resin (Piccolastic® D-150, from Hercules), 1% by weight of zinc oxide, 0.2% by weight of crosslinking agent (Tetrone® A, from DuPont), 0.4% by weight of accelerator (Butyl® 8, from R.T. Vanderbilt) and 54.1% by weight of toluene is prepared. The solution of flameproofed adhesive and sealing material (adhesive polymer and flameproofing agent) is applied as a coat to a protective aluminum foil substrate material and dried at room temperature and 70° C., in each case for 5 min. The layer thickness is 50 μm.

Sheet-like moldings of 1.6 mm thickness are cast from the solution of the flameproofed adhesive and sealing material and UL-94 test bars are cut out as moldings. The test results are shown in table 3. In the 180° peel test, a peel resistance of 6.1 N/mm is measured.

### EXAMPLE 29

An adhesive material is prepared from 83% by weight of solvent-containing polyether-based polyurethane adhesive (PSA® 2-25-3, from Mace Adhesives) and 1.7% by weight of crosslinking agent (XR®-2000, from Stahl) and 15% by weight of diethyl phosphinate 3 (from Clariant). This flameproofed adhesive and sealing material (adhesive polymer and flameproofing agent) is applied in a layer thickness of 20 μm to a 200 μm thick polyether-polyurethane film.

Sheet-like moldings of 1.6 mm thickness are cast from the solution of the flameproofed adhesive and sealing material and UL-94 test bars are cut out as moldings. The test results are shown in table 3. In the 180° peel test, a peel resistance of 0.3 N/mm is measured.

TABLE 1
Amounts used and results of the experiments

| | Example | | | | | | | | | | | |
|---|---|---|---|---|---|---|---|---|---|---|---|---|
| | 1 | 3 | 4 | 5 | 6 | 7 | 8 | 9 | 10 | 11 | 12 | 13 |
| Diethyl | | 10 | | | | | | | | | | |
| phosphinate 1 | | | | | | | | | | | | |
| Diethyl | | | | 1 | | 30 | | 30 | | 20 | | |
| phosphinate 2 | | | | | | | | | | | | |
| Diethyl | | | | | | | | | | | | 30 |
| phosphinate 3 | | | | | | | | | | | | |
| Zinc borate | | | | | | | | | | | | |
| Boron | | | | | | | | | | | | |
| phosphate | | | | | | | | | | | | |
| Melamine | | | | | | | | | | | | |
| polyphosphate | | | | | | | | | | | | |
| Melamine | | | | | | | | | | | | |
| cyanurate | | | | | | | | | | | | |
| Aluminum | | | | | | | | | | | | |
| phosphate | | | | | | | | | | | | |
| Piperazine | | | | | | | | | | | | |
| pyrophosphate | | | | | | | | | | | | |
| Zinc oxide | | | | | | | | | | | | |
| Zinc stearate | | | | | | | | | | | | |
| Remainder | 100 | 90 | 100 | 99 | 100 | 70 | 100 | 70 | 100 | 80 | 100 | 70 |
| (thermoplastic | | | | | | | | | | | | |
| polymer) | | | | | | | | | | | | |
| UL-94 | ncl | V-0 | V-1 | V-0 | ncl | V-0 | ncl | V-0 | ncl | V-0 | ncl | V-0 |
| classification | | | | | | | | | | | | |

TABLE 2
Amounts used and results of the experiments

| | Example | | | | | | | | | |
|---|---|---|---|---|---|---|---|---|---|---|
| | 14 | 15 | 16 | 17 | 18 | 19 | 20 | 21 | 22 | 23 |
| Diethyl | 4.75 | | | | | | 3 | | 16.25 | 14 |
| phosphinate 1 | | | | | | | | | | |
| Diethyl | | 18 | 16 | 7 | 12 | 15 | | 12 | | |
| phosphinate 2 | | | | | | | | | | |
| Diethyl | 0.25 | | | | | | | | | |
| phosphinate 3 | | | | | | | | | | |
| Zinc borate | | 2 | | | | | | 1 | | |
| Boron | | | 4 | | | | | | | |
| phosphate | | | | | | | | | | |
| Melamine | | | | 3 | | | | 7 | 6.25 | 14 |
| polyphosphate | | | | | | | | | | |
| Melamine | | | | | 8 | | | | | |
| cyanurate | | | | | | | | | | |
| Aluminum | | | | | | 15 | | | | |
| phosphate | | | | | | | | | | |
| Piperazine | | | | | | | 27 | | | |
| pyrophosphate | | | | | | | | | | |
| Zinc oxide | | | | | | | | | 2.5 | |
| Zinc stearate | | | | | | | | | | 7 |
| Remainder | 95 | 80 | 80 | 90 | 80 | 70 | 70 | 80 | 75 | 65 |
| (thermoplastic | | | | | | | | | | |
| polymer) | | | | | | | | | | |
| UL-94 | V-1 | V-0 | V-0 | V-0 | V-0 | V-0 | V-0 | V-0 | V-0 | V-0 |
| classification | | | | | | | | | | |

TABLE 3
Amounts used and results of the experiments

| | Example | | | | | |
|---|---|---|---|---|---|---|
| | 24 | 25 | 26 | 27 | 28 | 29 |
| Diethyl phosphinate 1 | | | | | | |
| Diethyl phosphinate 2 | 15 | 2 | | | 4 | |
| Diethyl phosphinate 3 | | | 9 | 15/16 | | 15 |
| Melamine polyphosphate | 7 | | | | | |
| Remainder | 54 | 73 | 65 | 85/84 | 68 | 56 |
| (adhesive polymer plus | | | | | | |
| solvent) | | | | | | |
| UL-94 classification | V-0 | V-0 | V-0 | V-0 | V-0 | V-0 |

TABLE 4
Chemicals used

| | |
|---|---|
| Diethyl phosphinate 1 | Exolit OP1230, median particle size 22 μm, |
| | from Clariant |
| Diethyl phosphinate 2 | Exolit OP935, median particle size 3 μm, from |
| | Clariant |
| Diethyl phosphinate 3 | Exolit OP950, median particle size 150 μm, |
| | from Clariant |
| Zinc borate | Firebrake 500, from Borax |
| Boron phosphate | from Aldrich |
| Melamine polyphosphate | Budit 3141, from Budenheim |
| Melamine cyanurate | Melapur MC, from Ciba SC |
| Aluminum phosphate | from Aldrich |
| Piperazine pyrophosphate | ADK Stab FP-4100, from Adeka |
| Zinc oxide | Zinc oxide active Rheinchemie |
| Zinc stearate | Liga 101, from Greven Fett-Chemie |

1. A flameproofed adhesive and sealing material comprising:
0.1-99.9% by weight of an adhesive polymer or thermoplastic polymer
0.1-99.9% by weight of a flameproofing agent, wherein the flameproofing agent contains at least one phosphinic acid salt of the formula (I), one diphosphinic acid salt of the formula (II) or a mixture thereof 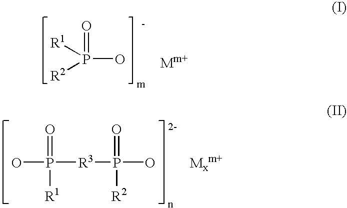
wherein
R¹, R² are identical or different and are C₁-C₆-alkyl, linear or branched or aryl;
R³ is C₁-C₁₀-alkylene, linear or branched, C₆-C₁₀-arylene, C₆-C₁₀-alkylarylene or C₆-C₁₀-arylalkylene;
M is Mg, Ca, Al, Zn, Sb, Sn, Ge, Zn, Ti, Fe, Zr, Ce, Bi, Sr, Mn, Li, Na, K or a protonated nitrogen base;
m is 1 to 4; n is 1 to 4 and x is 1 to 4, the adhesive polymer being acrylate resins, polyurethane resins, saturated and unsaturated polyester resins, styrene-butadiene copolymers, vinyl acetate copolymers, silicones, synthetic rubber, polyolefin resins or a mixture thereof.

2. The flameproofed adhesive and sealing material as claimed in claim 1, wherein R¹, R² are identical or different and are methyl, ethyl, n-propyl, isopropyl, n-butyl, sec-butyl, tert-butyl, n-pentyl or phenyl.

3. The flameproofed adhesive and sealing material as claimed in claim 1, wherein R³ is methylene, ethylene, n-propylene, isopropylene, n-butylene, tert-butylene, n-pentylene, n-octylene; phenylene, naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

4. The flameproofed adhesive and sealing material as claimed in claim 1, wherein the phosphinic acid salt of the formula (I) and/or the diphosphinic acid salt of the formula (II) are present in an amount of from 70 to 100% by weight in the flameproofing agent.

5. The flameproofed adhesive and sealing material as claimed in claim 1, wherein the flameproofing agent comprises
a) from 30 to 99.9% by weight of the phosphinic acid salt of the formula (I), the diphosphinic acid salt of the formula (II) or a mixture thereof and
b) from 0.1 to 70% by weight of a synergistic agent.

6. The flameproofed adhesive and sealing material as claimed in claim 1, wherein the flameproofing agent comprises
a) from 60 to 99% by weight of the phosphinic acid salt of the formula (I), the diphosphinic acid salt of the formula (II) or a mixture thereof and
b) from 1 to 40% by weight of a synergistic agent.

7. The flameproofed adhesive and sealing material as claimed in claim 5, wherein the synergistic agent comprises a nitrogen, phosphorus or phosphorus-nitrogen compound.

8. The flameproofed adhesive and sealing material as claimed in claim 5, wherein the synergistic agent is allantoin, cyanuric acid, glycoluril, urea, melamine, melam, melem, melon, melamine phosphate, melamine pyrophosphate, melamine polyphosphate, melam polyphosphate, melem polyphosphate, melon polyphosphate, melamine cyanurate, piperazine phosphate, piperazine pyrophosphate, carbodiimide, sterically hindered phenols, phosphine oxide, hypophosphite, cyclic phosphonates, triaryl(alkyl) phosphites, alkyl- and aryl-substituted phosphates, aluminum, tin, boron, magnesium, calcium and cerium compounds, zinc oxide, zinc carbonate, zinc stannate, zinc borate, zinc hydrogen phosphate, zinc pyrophosphate, zinc oleate, zinc stearate, zinc phosphate or a mixture thereof.

9. The flameproofed adhesive and sealing material as claimed in claim 1, wherein the adhesive polymer or thermoplastic polymer are those which are based on glue, cellulose, modified cellulose, cellulose derivatives, starch, amylose, amylopectin or polysaccharides.

10. The flameproofed adhesive and sealing material as claimed in claim 1, wherein the adhesive polymer or thermoplastic polymer are those which are based on an elastomer.

11. The flameproofed adhesive and sealing material as claimed in claim 1, wherein the adhesive polymer or thermoplastic polymer are those which are based on homopolymers or copolymers of ethylene, propylene, polyethylene, polypropylene, copolymers of ethylene, propylene or isobutene, homopolymers or copolymers of hydrocarbons having four or more carbon atoms and derivatives obtained by modification.

12. The flameproofed adhesive and sealing material as claimed in claim 1, wherein the thermoplastic is selected from the group consisting of ethylene copolymers, organopolysiloxanes, atactic poly-alpha-olefins (APAO), polyisobutylene, styrene-butadiene-styrene block polymers, styrene-isoprene-styrene block polymers, polyamides, polyesters, polyvinyl acetate plastomers, copolyesters, butyl rubbers, ternary and quaternary copolyamides, polyurethanes, epoxy resins and mixtures thereof.

13. A molding comprising a flameproofed adhesive and sealing material as claimed in claim 1.

14. The molding as claimed in claim 13, wherein the molding is a laminate comprising at least one nontacky substrate layer and at least one adhesive layer, wherein at least one of the layers contains the flameproofed adhesive and sealing material.

15. The molding as claimed in claim 13, wherein the molding consists of flexible copper-clad substrate, solder resist and the flameproofed adhesive and sealing material.

16. A process for making a molding as claimed in claim 13, wherein the molding has a substrate layer, comprising the steps of applying the flameproofed adhesive and sealing material to the substrate layer and curing the substrate layer by exposure to light.

17. A process for making a molding as claimed in claim 13, wherein the molding has a substrate film, comprising the step of laminating the flameproofed adhesive and sealing material with the substrate film.

18. A process for making a molding as claimed in claim 13, wherein the molding has a substrate material, comprising the step of coating the substrate material on both sides with the flameproofed adhesive and sealing material.

19. An article comprising a flameproofed adhesive and sealing material as claimed in claim 1, wherein the article is selected from the group consisting of flat cables, flexible circuit boards, interior automotive trim, electrical semiconductors, covering layers, optical films for the protection of windows from sunlight, circuit boards, optical conductors, coils for demagnetization, electrical assemblies, electrical insulation materials, medium- and high-voltage insulators, cable terminal boxes, cable sleeves, electrical or electronic or photovoltaic assemblies, for sealing, coatings, electrical conductors, diapers, hospital hygiene articles, feminine hygiene articles, operating theater requisites, incontinence articles, cardboard packaging, packaging materials, adhesive tapes, labels, insulating glass panes, adhesive bonds of pipes or injection molded parts, contact adhesive materials, printed circuit boards, heat-activatable contact adhesive tapes, electrical or electronic components and heat-curing epoxy molding compounds (EMC).

20. The flameproofed adhesive and sealing material as claimed in claim 10, wherein the elastomer is selected from the group consisting of natural rubber, homopolymers or copolymers of conjugated hydrocarbon dienes, chloroprene homopolymers or copolymers, elastomers containing carboxyl groups, rubber derivatives, regenerated material, synthetic rubber, acrylonitrile-butadiene rubber containing carboxyl groups, butyl rubber, elastomers based on homopolymers or copolymers of unsaturated aliphatic hydrocarbons having only one C═C double bond and the derivatives thereof.

21. The flameproofed adhesive and sealing material as claimed in claim 11, wherein the modification is selected from the group consisting of chemical after-treatment, reaction with halogens or halogen-containing compounds and oxidation.
